(19) United States
(12) Patent Application Publication
(10) Pub. No.: US 2024/0238158 A1
(43) Pub. Date: Jul. 18, 2024

(54) MULTIPURPOSE THERMOSTATIC UNDERWATER MASSAGER AND METHOD FOR USING SAME

(71) Applicant: JIANGSU LEGEND & COMCO OUTDOOR PRODUCTS CO., LTD, Huai'an, Jiangsu (CN)

(72) Inventor: Liang YAO, Huai'an, Jiangsu (CN)

(21) Appl. No.: 17/774,425

(22) PCT Filed: Jul. 14, 2021
(86) PCT No.: PCT/CN2021/106227

§ 371 Date: May 4, 2022

(30) Foreign Application Priority Data
Jan. 15, 2021 (CN) 202110053227.2

(51) Int. Cl. A61H 33/02

(52) U.S. Cl. CPC A61H 33/025; A61H 33/028; A61H 2201/0242

(57) ABSTRACT

The present invention relates to the technical field of massagers, and discloses a multipurpose thermostatic underwater massager, which includes a thermostatic principal machine, a duct switch for controlling output of gas flow, a cushion, an air outlet duct, an air outlet handle, and a first soft duct and a second soft duct for conveying gas flow. The duct switch is installed at the air outlet of the thermostatic principal machine, and the first soft duct and the second soft duct are respectively connected with the two outlets of the duct switch. The outlet of the second soft duct is communicated with the cushion, and the two ends of the air outlet duct are respectively communicated with the front and back of the cushion.

### FIELD OF THE PRESENT DISCLOSURE

The present disclosure relates to the technical field of massagers, in particular to a multipurpose thermostatic underwater massager and a method of using the same.

### BACKGROUND OF THE PRESENT DISCLOSURE

In recent years, bathing massage has become more and more fashionable, not only in health and/or physiotherapy centers, but also in domestic bathrooms or in hotels, providing users with constant water temperature and massaging a human body with water or gas flow.

The existing massager is often integrated with a bathtub, limiting application scenarios, for example, if used at home, its arrangement requires a large space with more limitations, making against the promotion of products.

### SUMMARY OF THE PRESENT DISCLOSURE

In view of the deficiencies of the prior art, the present disclosure provides a multipurpose thermostatic underwater massager, which has the advantages such as keeping the water temperature constant and adapting to various containers, and can provide a function of blowing with hot gas.

In order to solve the technical problem, the present disclosure adopts the following technical solution:

A multipurpose thermostatic underwater massager comprising a thermostatic principal machine, a duct switch for controlling output of gas flow, a cushion, an air outlet duct, an air outlet handle, and a first soft duct and a second soft duct for conveying gas flow;
the duct switch being installed at the air outlet of the thermostatic principal machine, and the first soft duct and the second soft duct being respectively connected with the two outlets of the duct switch;
the outlet of the second soft duct being communicated with the cushion, the two ends of the air outlet duct being respectively communicated with the front and back of the cushion, and the outlet of the first soft duct being communicated with the air outlet handle.

Further, the air outlet duct is composed of no less than three branch pipes connected together, a first air outlet is opened on the upper side of each branch pipe, a second air outlet in opened on the cushion, and the first air outlet and the second air outlet are used to blow with gas, form bubbles in water, heat and drive the water to flow.

Further, the bottom of the cushion and the lower side of each branch pipe are provided with suckers for fixing the cushion and the air outlet duct on the bottom of a water container.

Further, the end of the air outlet handle far away from the first soft duct is provided with a third air outlet, which is used for blowing with gas at different temperatures as a blower.

Further, when used in a container, the top of the first soft duct and the second soft duct is higher than the water surface, preventing water from flowing back from the first soft duct and the second soft duct to the thermostatic principal machine.

Further, the air outlet duct can be combined into various shapes and sizes such as a circle and a square according to the different shapes and sizes of the container, and the mouth of the branch pipe is provided with a quick joint.

A method of using a multipurpose thermostatic underwater massager comprising the following step:
A. putting a cushion and an air outlet duct into a water container, injecting hot water into the container, directing a first air outlet and a second air outlet upwards, and sucking the air outlet duct and the cushion on the bottom of the container by means of suckers;
B. controlling a thermostatic principal machine to output different temperatures and air volumes, controlling a duct switch to enable the air flow to pass through the first air outlet and the second air outlet so as to generate air bubbles, which drives the water flow and performs a function of massage in water, and which can bring hot air into the water and performs a function of maintaining the water temperature for a long time; after an user gets up from the water, adjusting the temperature and air volume of the thermostatic principal machine and the duct switch, holding an air outlet handle, using it as a hot air blower, and quickly blowing dry the human body.

Further, in step A, the air outlet duct can be assembled according to the size and shape of the water container, thereby adapting to different containers and being suitable for use in water containers with different sizes such as inflatable pools, support pools, mesh pools, bath tubs and the likes.

The present disclosure has beneficial effects as follows.
1. In the multipurpose thermostatic underwater massager, the air flow can pass through the first air outlet and the second air outlet to generate air bubbles, which drives the water flow and performs a function of massage in water. The device adopts a split design, the thermostatic principal machine is detachable from the air outlet duct, which can be assembled according to different requirements. The device can adapt to the water containers with different sizes such as inflatable pools, support pools, mesh pools, bath tubs and the likes and being suitable for most usage scenarios.
2. The multipurpose thermostatic underwater massager can provide hot gas through the third air outlet on the air outlet handle under the adjustment of the duct switch by making use of the design of the air outlet handle, so as to blow off the water on a human body with hot gas and provide a drying function.
3. The multipurpose thermostatic underwater massager applies a reacting force on the cushion and the air outlet duct to put them against the bottom of the container so as to stabilize them during blowing with gas through the first air outlet and the second air outlet, by making use of the design of the first air outlet and the second air outlet, and can avoid the cushion and the air outlet duct from moving after installation in coordination with the sucker, providing users with an excellent experience.
4. The multipurpose thermostatic underwater massager is designed with the air outlet duct spliced by multiple branch pipes and suitable for different sizes of water containers, and such design is convenient to package and transport after disassembly.

### BRIEF DESCRIPTION OF THE DRAWINGS

In order to illustrate the embodiments of the present disclosure or the technical solutions in the prior art more clearly, the figures necessary for the description of the embodiments or in the prior art will be briefly explained as follows.

FIG. 1 is a structure diagram of the present disclosure.

Where, thermostatic principal machine—1, duct switch—2, cushion—3, second air outlet two—31, air outlet duct—4, branch pipe—41, first air outlet one—42, air outlet handle—5, third air outlet three—51, first soft duct—6, second soft duct—7, sucker—8.

### DETAILED DESCRIPTION OF THE PRESENT DISCLOSURE

The technical solutions in the embodiments of the present disclosure will be clearly and completely described in combination with the figures in the examples of the present disclosure as follows.

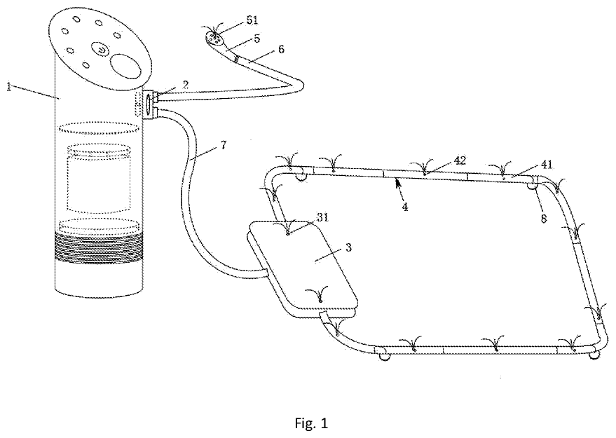

With reference to FIG. 1, a multipurpose thermostatic underwater massager and a method of using the same include a thermostatic principal machine 1, a duct switch 2 for controlling output of gas flow, a cushion 3, an air outlet duct 4, an air outlet handle 5, and a first soft duct 6 and a second soft duct 7 for conveying gas flow.

The duct switch 2 is installed at the air outlet of the thermostatic principal machine 1, and the first soft duct 6 and the second soft duct 7 are respectively connected with the two outlets of the duct switch 2. The duct switch 2 is a three-phase valve, which is used to switch the gas supply of the first soft duct 6 and the second soft duct 7.

The outlet of the second soft duct 7 is communicated with the cushion 3, the two ends of the air outlet duct 4 are respectively communicated with the front and back of the cushion 3, and the outlet of the first soft duct 6 is communicated with the air outlet handle 5.

The air outlet duct 4 is composed of no less than three branch pipes 41 connected together; the first air outlet 42 is opened on the upper side of each branch pipe 41, and the second air outlet 31 in opened on the cushion 3. The first air outlet 42 and the second air outlet 31 are used to blow with gas, form bubbles in water, heat and drive the water to flow, ensuring the water within the water container in a constant temperature state, and providing users with superior enjoyment.

The bottom of the cushion 3 and the lower side of each branch pipe 41 are provided with the suckers 8 for fixing the cushion 3 and the air outlet duct 4 on the bottom of the water container.

The end of the air outlet handle 5 far away from the first soft duct 6 is provided with the third air outlet 51, which is used for blowing with hot air as a blower.

The first soft duct 6 and the second soft duct 7 both can only be put into water from the bottom of the container to prevent water from flowing back from the first soft duct 6 and the second soft duct 7 to the thermostatic principal machine 1, When the second soft duct 7 is partially in use, the part of the duct is above the water surface, preventing water from flowing into the thermostatic principal machine 1 and the thermostatic principal machine 1 from damage or other safety accidents.

The air outlet duct 4 can be combined into various shapes and sizes such as a circle and a square according to the different shapes and sizes of the containers. The branch pipe 41 uses a soft plastic pipe, and the mouth of the branch pipe 41 is provided with a quick joint, which is convenient for the air outlet duct 4 to quickly assembly and disassembly.

A method of using a multipurpose thermostatic underwater massager includes the following step:
A. putting the cushion 3 and the air outlet duct 4 into the water container, injecting hot water into the container, directing the first air outlet 42 and the second air outlet 31 upwards, and sucking the air outlet duct 4 and the cushion 3 on the bottom of the container by means of the sucker 8;
B. controlling the thermostatic principal machine 1 to output different temperatures and air volumes, controlling the duct switch 2 to enable the air flow to pass through the first air outlet 42 and the second air outlet 31 so as to generate air bubbles, which drives the water flow and performs a function of massage in water, and which can bring hot air into the water and performs a function of maintaining the water temperature for a long time; after the user gets up from the water, adjusting the temperature and air volume of the thermostatic principal machine 1 and the duct switch 2, holding the air outlet handle 5, using it as a hot air blower, and quickly blowing dry the human body.

In step A, the air outlet duct 4 can be assembled according to the size and shape of the water container, thereby adapting to different containers and being suitable for use in water containers with different sizes such as inflatable pools, support pools, mesh pools, bath tubs and the likes.

In summary, in the multipurpose thermostatic underwater massager, the air flow can pass through the first air outlet 42 and the second air outlet 31 to generate air bubbles, which drives the water flow and performs a function of massage in water. The device adopts a split design, the thermostatic principal machine 1 is detachable from the air outlet duct 4, which can be assembled according to different requirements. The device can adapt to the water containers with different sizes such as inflatable pools, support pools, mesh pools, bath tubs and the likes and is suitable for most usage scenarios. The device can provide hot gas through the third air outlet 51 on the air outlet handle 5 under the adjustment of the duct switch 2 by making use of the design of the air outlet handle 5, so as to blow off the water on a human body with hot gas and provide a drying function. The device applies a reacting force on the cushion 3 and the air outlet duct 4 to put them against the bottom of the container so as to stabilize them during blowing with gas through the first air outlet 42 and the second air outlet 31, by making use of the design of the first air outlet 42 and the second air outlet 31, and can avoid the cushion 3 and the air outlet duct 4 from moving after installation in coordination with the sucker 8, providing users with an excellent experience. The device is designed with the air outlet duct 4 spliced by multiple branch pipes 41 and suitable for different sizes of water containers, and such design is convenient to package and transport after disassembly.

The above description of the disclosed embodiments aims to enable a person skilled in the art to implement or apply the present disclosure. It is obvious for a person skilled in the art to make various modifications to these embodiments, and implement the generic principle defined herein in other embodiments without departing from the spirit or scope of the invention. Thus, the present disclosure is not intended to be limited to the embodiments shown herein, but in accord with the widest scope consistent with the principle and novel features disclosed.

What is claimed is:

1. A multipurpose thermostatic underwater massager comprising a thermostatic principal machine (1), a duct switch (2) for controlling output of gas flow, a cushion (3), an air outlet duct (4), an air outlet handle (5), and a first soft duct (6) and a second soft duct (7) for conveying gas flow;
said duct switch (2) being installed at the air outlet of said thermostatic principal machine (1), and said first soft duct (6) and said second soft duct (7) being respectively connected with the two outlets of said duct switch (2);
the outlet of said second soft duct (7) being communicated with said cushion (3), the two ends of said air outlet duct (4) being respectively communicated with the front and back of said cushion (3), and the outlet of said first soft duct (6) being communicated with said air outlet handle (5).

2. The multipurpose thermostatic underwater massager according to claim 1, wherein said air outlet duct (4) is composed of no less than three branch pipes (41) connected together, a first air outlet (42) is opened on the upper side of each branch pipe (41), a second air outlet (31) in opened on said cushion (3), and said first air outlet (42) and said second air outlet (31) are used to blow with gas, form bubbles in water, heat and drive the water to flow.

3. The multipurpose thermostatic underwater massager according to claim 2, wherein the bottom of said cushion (3) and the lower side of each branch pipe (41) are provided with suckers (8) for fixing said cushion (3) and said air outlet duct (4) on the bottom of a water container.

4. The multipurpose thermostatic underwater massager according to claim 3, wherein the end of said air outlet handle (5) far away from said first soft duct (6) is provided with a third air outlet (51), which is used for blowing with gas at different temperatures as a blower.

5. The multipurpose thermostatic underwater massager according to claim 4, wherein when used in a container, the top of said first soft duct (6) and said second soft duct (7) is higher than the water surface, preventing water from flowing back from said first soft duct (6) and said second soft duct (7) to said thermostatic principal machine (1).

6. The multipurpose thermostatic underwater massager according to claim 5, wherein said air outlet duct (4) can be combined into various shapes and sizes such as a circle and a square according to the different shapes and sizes of the container, and the mouth of said branch pipe (41) is provided with a quick joint.

7. A method of using a multipurpose thermostatic underwater massager comprising the following step:
A. putting a cushion (3) and an air outlet duct (4) into a water container, injecting hot water into the container, directing a first air outlet (42) and a second air outlet (31) upwards, and sucking said air outlet duct (4) and said cushion (3) on the bottom of the container by means of suckers (8);
B. controlling a thermostatic principal machine (1) to output different temperatures and air volumes, controlling a duct switch (2) to enable the air flow to pass through said first air outlet (42) and said second air outlet (31) so as to generate air bubbles, which drives the water flow and performs a function of massage in water, and which can bring hot air into the water and performs a function of maintaining the water temperature for a long time; after an user gets up from the water, adjusting the temperature and air volume of said thermostatic principal machine (1) and said duct switch (2), holding an air outlet handle (5), using it as a hot air blower, and quickly blowing dry the human body.

8. The method of using a multipurpose thermostatic underwater massager according to claim 7, wherein in step A, said air outlet duct (4) can be assembled according to the size and shape of the water container, thereby adapting to different containers and being suitable for use in water containers with different sizes such as inflatable pools, support pools, mesh pools, bath tubs and the likes.
